(19) United States
(12) Patent Application Publication
(10) Pub. No.: US 2022/0107133 A1
(43) Pub. Date: Apr. 7, 2022

(54) MULTI-UNIT COMPRESSED AIR DRYING SYSTEM

(71) Applicant: Ingersoll-Rand Industrial U.S., Inc., Davidson, NC (US)

(72) Inventors: Kumar Arpit, Kidwai Nagar (IN); Indira Priyadarshini Rambhatla, Davidson, NC (US); Zekai He, Davidson, NC (US)

(21) Appl. No.: 17/062,719

(22) Filed: Oct. 5, 2020

(51) Int. Cl. F26B 21/00; F26B 25/00

(52) U.S. Cl. CPC F26B 21/001; F26B 25/008

(57) ABSTRACT

A compressed air drying system is provided for removing moisture from compressed air. The system includes multiple air dryers that each remove moisture from a portion of the compressed air. The air dryers share a reservoir of liquid coolant that is used to cool the compressed air in each of the drying units. The reservoir has inlets for each of the drying units for the liquid coolant to return from the respective unit to the reservoir. The inlets are arranged in the reservoir to mix the incoming liquid coolant from the inlets to ensure that warm coolant from one of the inlets does not flow directly to an outlet of the reservoir.

### BACKGROUND

The present inventions relate generally to industrial air dryers for compressed air systems.

Compressed air is commonly used in factories to power pneumatic tools and to blow air onto various surfaces for cleaning, expanding bags, moving parts, etc. Typically, factories have a centralized compressed air system installed that feeds a network of compressed air piping that supplies numerous tools or stations with compressed air. Thus, one or more centralized air compressors may be used to supply an entire factory space with compressed air.

However, it is known that air compressors which draw air from the surrounding atmosphere also introduce moisture into the compressed air from the water vapor naturally contained in atmospheric air. Moisture within compressed air used in factories can cause numerous problems. For example, in the case of power tools that use compressed air as a power source, moisture within the supplied compressed air can cause corrosion of the internal components of the tool. In addition, where compressed air is blown onto surfaces, any moisture within the compressed air will also be blown onto the surface along with the blown air. This can be particularly problematic where it is a requirement that the surface remain dry, such as food packaging operations, and can also be a problem with delicate surfaces that might be damaged by water particles within the compressed air.

Due to the problems associated with moisture within compressed air systems, various types of air drying systems may be used in industrial factories to remove moisture contained within compressed air. While such systems are useful and adequately address the potential problems associated with moisture in compressed air, such systems can be expensive to operate and maintain. Thus, it would be desirable to provide improved air drying systems for industrial factories.

### SUMMARY

A compressed air drying system is described for removing moisture from compressed air. The system includes a reservoir of liquid coolant that is shared between multiple air drying units. Liquid coolant from the reservoir flows to a heat exchanger in each of the drying units to cool compressed air flowing through each drying unit. The liquid coolant is mixed in the reservoir to ensure that warm coolant from one of the drying units does not flow directly into one of the outlets. The invention may also include any other aspect described below in the written description or in the attached drawings and any combinations thereof.

### BRIEF DESCRIPTION OF SEVERAL VIEWS OF THE DRAWINGS

The invention may be more fully understood by reading the following description in conjunction with the drawings, in which:

FIG. 1 is a perspective view of an air drying system;

FIG. 2 is a schematic view of an air drying system;

FIG. 3 is a perspective view of the internal components of an air drying system;

FIG. 4 is a perspective schematic view of a reservoir with inlets and outlets;

FIG. 5 is a perspective schematic view of a reservoir with inlets and outlets and a baffle therebetween;

FIG. 6 is a perspective schematic view of a reservoir with inlets and outlets where two inlets face each other and another inlet is angled relative to the other two inlets;

FIG. 7 is a perspective schematic view of a reservoir with a mixing container;

FIG. 8 is a simulation of the liquid coolant flows of the embodiment of FIG. 6;

FIG. 9 is a perspective cross-sectional view of a reservoir and a mixing container therein; and

FIG. 10 is a perspective view of the mixing container of FIG. 9 inside the reservoir.

### DETAILED DESCRIPTION

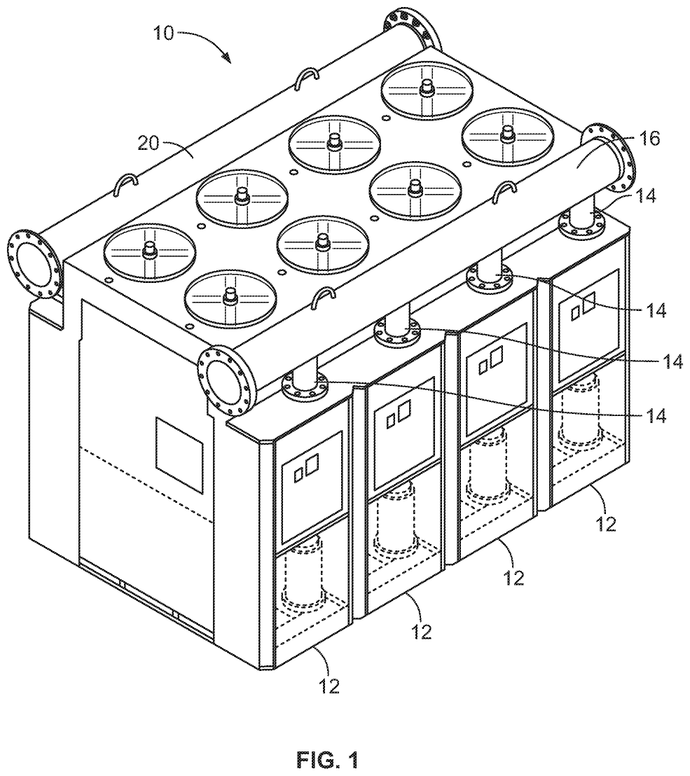

Referring now to the figures, and particularly FIG. 1, an industrial air drying system 10 for an industrial factory is shown. The air drying system 10 is designed as a multi-unit system 10 that can be sized to the particular factory installation by adding additional units 12 as needed. Thus, in the air drying system 10 shown in FIG. 1, the system 10 includes four air drying units 12. However, it is understood that the system 10 may also include two units 12, three units 12, five units 12 or more in order to accommodate the capacity requirements needed at the particular factory installation.

As shown, all of the air inlets 14 of the drying units 12 may be connected to a common inlet air header 16. The inlet air header 16 is typically a metal pipe with a larger passageway than the air inlets 14 of the individual drying units 12. The inlet air header 16 is connected to a compressed air supply which typically includes one or more air compressors that draw air from the surrounding atmosphere and compresses it to a pressure between 100-200 psi. Similarly, all of the air outlets 18 of the drying units 12 may be connected to a common outlet air header 20. The outlet air header 20 is also typically a metal pipe with a larger passageway than the air outlets 18 of the individual drying units 12. The outlet air header 20 is connected to a network of tools or stations in the factory that use the compressed air for a variety of uses. It is understood that the compressed air system 10 is also likely to have various compressed air storage tanks between the compressor(s) and the air drying system 10 and/or between the air drying system 10 and the tools and/or stations where the compressed air is used. It is also understood that each drying unit 12 may be provided with a separate control panel and controller to control the various functions of the air dryer 12 or a common controller may be provided for the entire system 10.

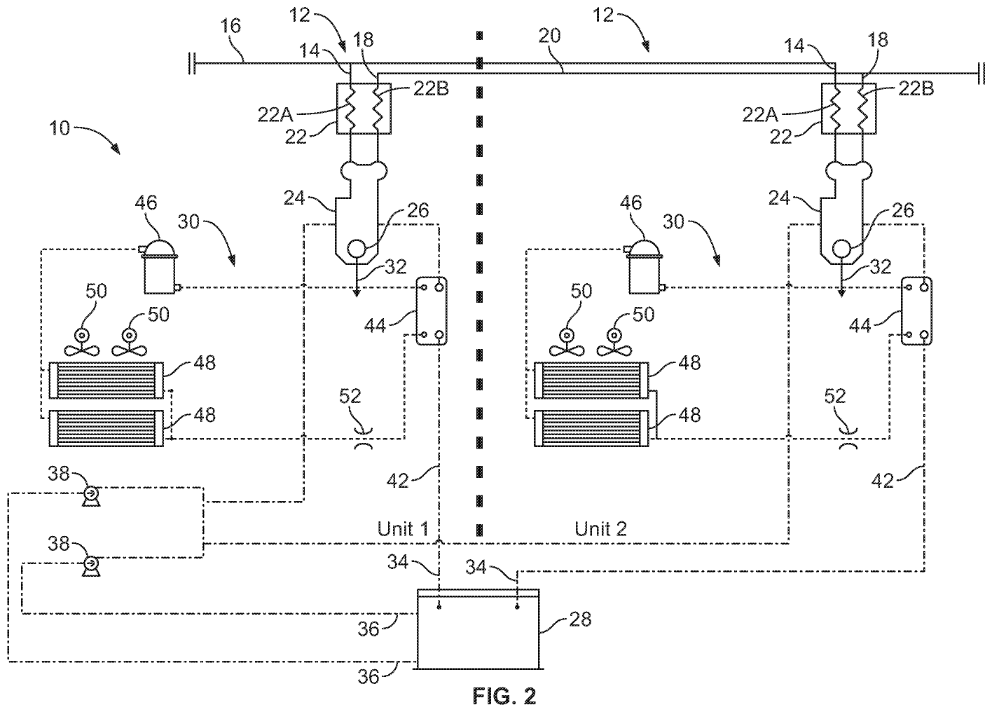

Turning to FIG. 2, a schematic of two of the air drying units 12 is shown. It is understood that the air drying units 12 preferably have a common design for manufacturing efficiency and for maintenance simplicity. As illustrated in FIG. 1, the air drying units 12 are also arranged in parallel with each other between the compressed air supply and the compressed air demand. In other words, when multiple air drying units 12 are operating at the same time, the compressed air flow from the supply is split into separate portions that flow through separate drying units 12. The portions may then be recombined after flowing through the multiple drying units 12 to be supplied to the compressed air demand. Because the drying units 12 are arranged in parallel with each other, maintenance can be further simplified since one of the drying units 12 can be taken out of operation temporarily for repair while the remaining drying units 12 continue to operate.

Referring to the first air drying unit 12 in FIG. 2, compressed air from the air inlet 12 preferably enters the precooler side 22A of a precooler/re-heater 22. The air then exits the precooler/re-heater 22 and enters a main cooler 24. After cooling the compressed air, the air enters a moisture separator 26. The moisture separator 26 may be within the main cooler 24 or may be a separate component located after the main cooler 24. The air then reenters the precooler/re-heater 22 on the re-heater side 22B, and thereafter, exits the air dryer 12 through the air outlet 18.

The precooler/re-heater 22 is a heat exchanger 22 that exchanges heat between the incoming air flow and the outgoing air flow. That is, the incoming air flow is warm relative to the outgoing air flow. As described below, the air is cooled within the dryer 12 to withdraw moisture from the air. Thus, the precooler/re-heater 22 increases efficiency by cooling the incoming air with the outgoing air prior to additional cooling that occurs thereafter. Also, it is undesirable for the outgoing air to be too cool since this would cool the compressed air piping and cause condensation of water vapor on the exterior of the piping. Thus, the precooler/re-heater 22 prevents this from happening by heating the outgoing air using the warm incoming air.

The main cooler 24 is another heat exchanger 24 that performs the primary cooling of the compressed air. As described further below, the main cooler 24 may use a liquid coolant, such as a glycol and water mixture, to cool the compressed air. The liquid coolant may be stored in a shared reservoir 28 and may be cooled by separate refrigerant cooling systems 30 in each of the drying units 12. After the compressed air has been cooled by the main cooler 24 (e.g., to below 5° C.), the moisture separator 26 withdraws moisture from the compressed air. The withdrawn moisture is then removed through a drain 32. Thus, the compressed air entering the re-heater side 22B of the precooler/re-heater 22 and exiting the dryer 12 has been dried by removing water vapor from the compressed air. It is understood that airflow through the air dryer 12 need not be separately forced or circulated therethrough, but instead may flow through the dryer 12 as air is used by the compressed air demand and replaced by the compressed air supply. That is, any compressed air that flows to the compressed air demand from the compressed air supply must first pass through the dryer 12 (or another dryer 12 in the system 10) due to the location of the dryer 12 between the supply and demand.

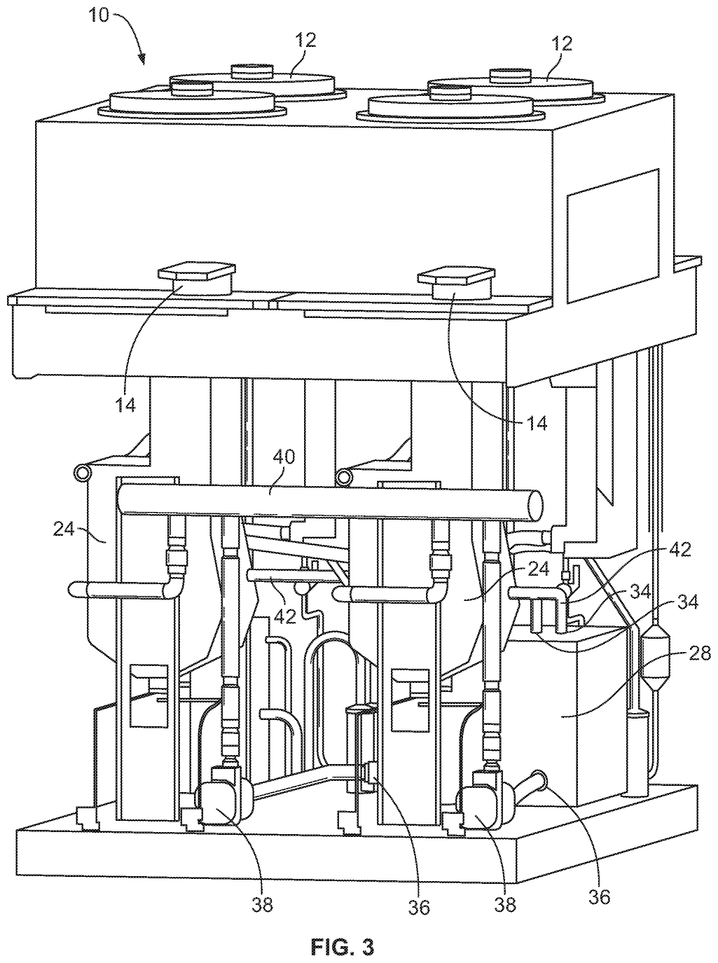

As shown in FIG. 3, the liquid coolant reservoir 28 may be located within one of the drying units 12 and shared among multiple air drying units 12. As shown in FIG. 2, each drying unit 12 may have an inlet 34 and an outlet 36 connected to the reservoir 28. A portion of the liquid coolant flows through each of the outlets 36 to the main cooler 24 in the respective air drying unit 12 and flows back from the main cooler 24 to the respective reservoir inlet 34. Preferably, each of the drying units 12 is provided with a separate fluid pump 38 for circulating the liquid coolant from the reservoir 28 to the respective main cooler 24 and back again. As shown in FIG. 3, the outlets 36 may be connected to a common header 40 for distributing the liquid coolant to each of the drying unit 12 main coolers 24 if desired. It is also possible for the reservoir 28 to have a single outlet 36 shared by the drying units 12. However, it is preferable for coolant to flow directly from each of the main coolers 24 to the reservoir 28 in separate pipes 42 without flowing through a common header or other pre-mixing prior to entering the reservoir 28.

Preferably, the liquid coolant is cooled in each of the drying units 12 by a separate refrigerant cooling system 30 in each unit 12. Thus, each of the drying units 12 has a refrigerant heat exchanger 44. The portion of liquid coolant flowing to a respective drying unit 12 may then flow through one side of the refrigerant heat exchanger 44 as the liquid coolant flows back from the main cooler 24 to the reservoir 28. A refrigerant flows through the other side of the refrigerant heat exchanger 44 to cool the liquid coolant. The refrigerant side of the refrigerant heat exchanger 44 may be considered to be an evaporator where the refrigerant evaporates and absorbs heat from the liquid coolant side of the refrigerant heat exchanger 44. The refrigerant vapor is then compressed to a higher pressure (and higher temperature) by a refrigerant compressor 46. The refrigerant then passes through a refrigerant condenser 48 that cools and liquefies the refrigerant. The condenser 48 is another heat exchanger 48 with a fan 50 that blows ambient air across the condenser 48 to dissipate heat from the refrigerant. An expansion valve 52 then reduces the pressure and temperature of the liquid refrigerant (e.g., to convert the refrigerant to a vapor). The low pressure, low temperature refrigerant then absorbs heat from the liquid coolant within the refrigerant heat exchanger 44, which results in lowering the temperature of the liquid coolant.

Thus, cooling of the liquid coolant is distributed between the refrigerant cooling systems 30 of the air drying units 12. That is, each of the refrigerant cooling systems 30 cools the portion of liquid coolant that flows through the respective air drying unit 12. As a result, the liquid coolant in the shared reservoir 28 is cooled by a combination of multiple refrigeration systems 30, and the average temperature of the liquid coolant in the reservoir 28 is determined by the cooling contributed by the multiple refrigeration systems 30 together. This allows the refrigeration systems 30 of the multiple drying units 12 to operate independently of each other. For instance, the refrigeration system 30 of one of the drying units 12 may be turned off while one or more of the refrigeration systems 30 in the other drying units 12 continues to operate. This may be useful to improve energy efficiency of the air drying system 10 by shutting down one or more of the refrigeration systems 30 when compressed air demand is low.

When the refrigeration system 30 of a drying unit 12 is off, the respective drying unit 12 may continue to cool compressed air with the liquid coolant. However, the drying unit 12 with a refrigeration system 30 that has been shut off does not contribute to cooling the liquid coolant. In this case, the liquid coolant acts as a heat sink and stores cold energy that has been contributed by the other drying units 12 with refrigeration systems 30 that are running. Thus, all of the drying units 12 can continue to cool compressed air but with less overall energy needed since not all of the refrigeration systems 30 may be running if compressed air demand is low. Although FIG. 2 shows two air drying units 12 sharing one liquid coolant reservoir 28, it is also possible for more than two air drying units 12 to share the liquid coolant reservoir 28. In particular, it is expected that three air drying units 12 will commonly share a liquid coolant reservoir 28 as described. It is further expected that the improved temperature mixing described herein may allow even more drying units 12 to share a liquid coolant reservoir 28 such that at least four drying units 12 may share a liquid coolant reservoir 28 as described.

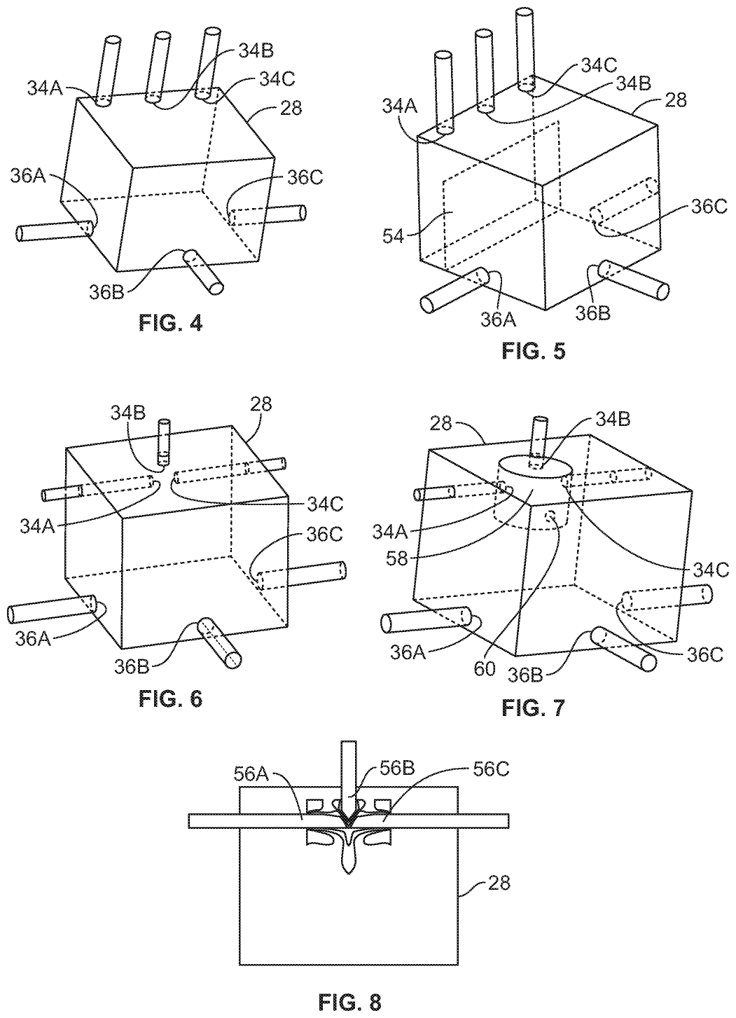

Although an air drying unit 12 with a refrigeration system 30 that has been turned off may continue to cool compressed air as described above by relying upon cold energy contributed to the liquid coolant by the other refrigeration systems 30, the liquid coolant returning to the reservoir 28 from a drying unit 12 with a disabled refrigeration system 30 will be warmer than the liquid coolant returning from drying units 12 with operating refrigeration systems 30. This may result in an uneven temperature of the liquid coolant in the reservoir 28, and as a result, liquid coolant with different temperatures may be sent to different drying units 12 through the outlets 36. For example, as shown in FIG. 4, where a drying system 10 has three drying units 12, the reservoir 28 may have three inlets 34A, B, C and three outlets 36A, B, C, i.e., one inlet 34 and one outlet 36 for each drying unit 12. However, in FIG. 4 there is no arrangement in the reservoir 28 to mix the portions of liquid coolant entering through the inlets 34. Thus, it is possible for liquid coolant to pass generally unimpeded from the first inlet 34A to the first outlet 36A. Likewise, liquid coolant may flow generally unimpeded between the second inlet 34B and the second outlet 36B and between the third inlet 34C and the third outlet 36C. This is undesirable because warm liquid coolant entering from a drying unit 12 with a refrigeration system 30 that has been turned off may flow out of the reservoir 28 back to a drying unit 12 without being cooled by the portions of liquid coolant that have been cooled by the other refrigeration systems 30.

Therefore, it is desirable to provide an arrangement in the reservoir 28 that mixes the incoming liquid coolant portions before the liquid coolant exits through the outlets 36. One such arrangement is shown in FIG. 5. As shown, a baffle 54 may be provided in the reservoir 28 between the inlets 34 and the outlets 36. In this arrangement, the baffle 54 prevents the incoming liquid coolant from passing directly between one of the inlets 34 and one of the outlets 36. Instead, the baffle 54 inhibits direct flow between the inlets 34 and outlets 36. As a result, the liquid coolant from the inlets 34 mixes together on the side of the baffle 54 where the inlets 34 are located before passing around the baffle 54 to the side where the outlets 36 are located.

Another arrangement is shown in FIG. 6. As shown, two of the inlets 34A, C face each other and one of the inlets 34B is aligned with the other inlets 34A, C at an angle (90°) relative to the other two inlets 34A, C. In FIG. 8, the incoming liquid coolant flows 56A, B, C of FIG. 6 are illustrated. As shown, the liquid coolant flows 56A, C from the inlets 34A, C facing each other collide with each other to cause mixing therebetween. The other liquid coolant flow 56B that is angled relative to the other two liquid coolant flows 56A, C shears across the liquid coolant flows 56A, C to further mix the incoming liquid coolant flows 56A, B, C.

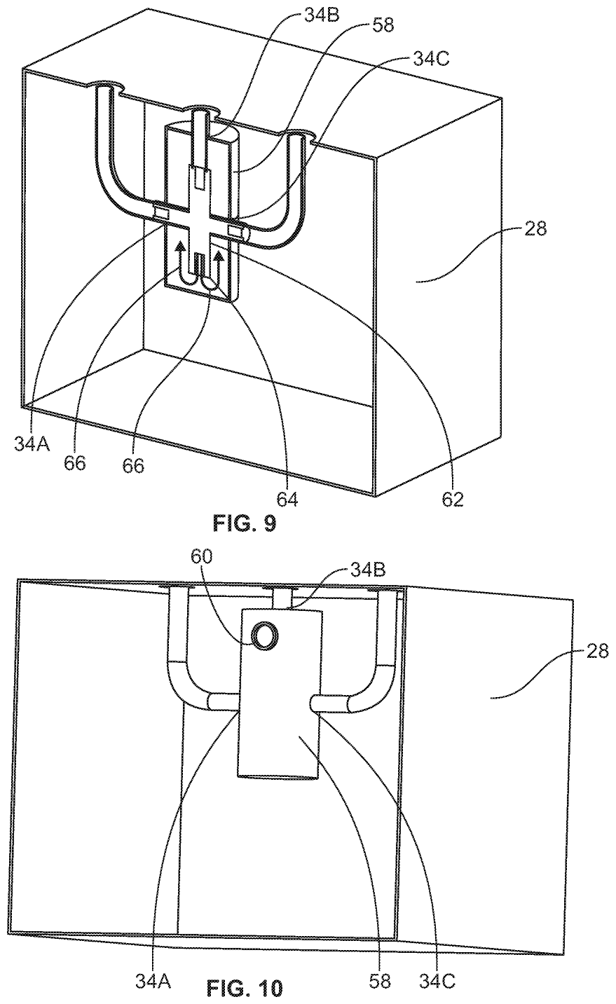

As shown in FIG. 7, a mixing container 58 may also be provided within the reservoir 28. In this arrangement, the inlets 34 are inside of the mixing container 58 such that the incoming liquid coolant flows mix together before exiting an opening 60 in the mixing container 58 to pass to the interior of the reservoir 28. Another alternative of this arrangement is illustrated in FIGS. 9-10. As shown, the inlets 34 may be combined with a joint 62 such that the liquid coolant of the inlets 34 exits together into the mixing container 58 through a combined inlet 64. As shown, it may be desirable for the liquid coolant 66 to enter the mixing container 58 in one direction (e.g., downwards) and then be forced by the container 58 to reverse direction (e.g., upwards) before exiting the opening 60. Additionally, while it is possible for the mixing container 58 to have multiple exit openings 60, it may be more desirable for the mixing container 58 to have a single exit opening 60 so that all of the liquid coolant must exit through the same opening 60.

While preferred embodiments of the inventions have been described, it should be understood that the inventions are not so limited, and modifications may be made without departing from the inventions herein. While each embodiment described herein may refer only to certain features and may not specifically refer to every feature described with respect to other embodiments, it should be recognized that the features described herein are interchangeable unless described otherwise, even where no reference is made to a specific feature. It should also be understood that the advantages described above are not necessarily the only advantages of the inventions, and it is not necessarily expected that all of the described advantages will be achieved with every embodiment of the inventions. The scope of the inventions is defined by the appended claims, and all devices and methods that come within the meaning of the claims, either literally or by equivalence, are intended to be embraced therein.

1. A compressed air drying system, comprising:
a first drying unit with a first compressed air inlet and a first compressed air outlet and a first heat exchanger therebetween, a first portion of compressed air flowing through one side of the first heat exchanger and a first portion of liquid coolant flowing through another side of the first heat exchanger, the first portion of the liquid coolant thereby cooling the first portion of the compressed air;
a second drying unit with a second compressed air inlet and a second compressed air outlet and a second heat exchanger therebetween, a second portion of the compressed air flowing through one side of the second heat exchanger and a second portion of the liquid coolant flowing through another side of the second heat exchanger, the second portion of the liquid coolant thereby cooling the second portion of the compressed air;
a reservoir containing the liquid coolant and comprising first and second inlets and one or more outlets, the first portion of the liquid coolant flowing from the one or more outlets to the first heat exchanger and from the first heat exchanger to the first inlet, and the second portion of the liquid coolant flowing from the one or more outlets to the second heat exchanger and from the second heat exchanger to the second inlet;
wherein the first and second inlets are arranged to mix the first and second portions of the liquid coolant between the first inlet and the one or more outlets and between the second inlet and the one or more outlets.

2. The compressed air drying system according to claim 1, further comprising a third drying unit with a third compressed air inlet and a third compressed air outlet and a third heat exchanger therebetween, a third portion of the compressed air flowing through one side of the third heat exchanger and a third portion of the liquid coolant flowing through another side of the third heat exchanger, the third portion of the liquid coolant thereby cooling the third portion of the compressed air, the reservoir further comprising a third inlet, the third portion of the liquid coolant flowing from the one or more outlets to the third heat exchanger and from the third heat exchanger to the third inlet, wherein the first, second and third inlets are arranged to mix the first, second and third portions of the liquid coolant between the first inlet and the one or more outlets, between the second inlet and the one or more outlets, and between the third inlet and the one or more outlets.

3. The compressed air drying system according to claim 1, further comprising at least four of the first and/or second drying units, the reservoir comprising at least four of the first or second inlets arranged to mix respective portions of the liquid coolant between each of the inlets and the one or more outlets.

4. The compressed air drying system according to claim 1, wherein the first and second inlets face each other such that the first and second portions of the liquid coolant collide with each other as the first and second portions of the liquid coolant exit the first and second inlets.

5. The compressed air drying system according to claim 1, wherein the first and second inlets are aligned with each other at an angle relative to each other such that the first and second portions of the liquid coolant shear across each other as the first and second portions of the liquid coolant exit the first and second inlets.

6. The compressed air drying system according to claim 1, wherein the first and second inlets are arranged on one side of a baffle and the one or more outlets is arranged on another side of the baffle.

7. The compressed air drying system according to claim 1, further comprising a mixing container within the reservoir, the first and second inlets being within the mixing container and an opening in the mixing container communicating the liquid coolant from within the mixing container to the reservoir outside of the mixing container.

8. The compressed air drying system according to claim 7, wherein the mixing container comprises a single one of the opening.

9. The compressed air drying system according to claim 7, wherein the first and second inlets are joined within the mixing container to form a combined inlet within the mixing container.

10. The compressed air drying system according to claim 7, wherein the first and second portions of the liquid coolant enter an interior of the mixing container in one direction and reverse direction within the mixing container to exit the opening.

11. The compressed air drying system according to claim 1, wherein each of the first and second drying units further comprises a separate refrigerant cooling system comprising a refrigerant compressor, a condenser and a refrigerant circulating therethrough, and each of the first and second drying units further comprises a separate refrigerant heat exchanger with the refrigerant flowing through one side of the refrigerant heat exchanger and the respective first and second portions of the liquid coolant flowing through another side of the refrigerant heat exchanger, the refrigerant thereby cooling the respective first and second portions of the liquid coolant.

12. The compressed air drying system according to claim 11, wherein the separate refrigerant cooling systems operate independently of each other such that the refrigerant cooling system of the first drying unit operates during a time when the refrigerant cooling system of the second drying unit is not operating, the second portion of the liquid coolant thereby being warmer than the first portion of the liquid coolant.

13. The compressed air drying system according to claim 1, wherein the first and second portions of the liquid coolant flow directly from the first and second heat exchangers to the first and second inlets through separate pipes without mixing prior to entering the reservoir.

14. The compressed air drying system according to claim 1, wherein each of the first and second drying units further comprises a separate fluid pump circulating the respective first and second portions of the liquid coolant through the first and second drying units.

15. The compressed air drying system according to claim 1, wherein the first and second portions of compressed air are separate from each other.

16. The compressed air drying system according to claim 1, wherein the one or more outlets comprises a separate outlet for each of the first and second drying units.

17. The compressed air drying system according to claim 1, wherein each of the first and second drying units further comprises a separate refrigerant cooling system comprising a refrigerant compressor, a condenser and a refrigerant circulating therethrough, and each of the first and second drying units further comprises a separate refrigerant heat exchanger with the refrigerant flowing through one side of the refrigerant heat exchanger and the respective first and second portions of the liquid coolant flowing through another side of the refrigerant heat exchanger, the refrigerant thereby cooling the respective first and second portions of the liquid coolant, and the first and second portions of the liquid coolant flow directly from the first and second heat exchangers to the first and second inlets through separate pipes without mixing prior to entering the reservoir.

18. The compressed air drying system according to claim 17, further comprising a third one of the first or second drying unit with a third compressed air inlet and a third compressed air outlet and a third heat exchanger therebetween, a third portion of the compressed air flowing through one side of the third heat exchanger and a third portion of the liquid coolant flowing through another side of the third heat exchanger, the third portion of the liquid coolant thereby cooling the third portion of the compressed air, the reservoir further comprising a third inlet, the third portion of the liquid coolant flowing from the one or more outlets to the third heat exchanger and from the third heat exchanger to the third inlet, wherein the first, second and third inlets are arranged to mix the first, second and third portions of the liquid coolant between the first inlet and the one or more outlets, between the second inlet and the one or more outlets, and between the third inlet and the one or more outlets.

19. The compressed air drying system according to claim 18, further comprising a mixing container within the reservoir, the first, second and third inlets being within the mixing container and an opening in the mixing container communicating the liquid coolant from within the mixing container to the reservoir outside of the mixing container.

20. The compressed air drying system according to claim 19, wherein each of the first, second and third drying units comprises a separate refrigerant cooling system, the separate refrigerant cooling systems operate independently of each other such that the refrigerant cooling systems of the first and second drying units operate during a time when the refrigerant cooling system of the third drying unit is not operating, the third portion of the liquid coolant thereby being warmer than the first and second portions of the liquid coolant, and each of the first, second and third drying units further comprises a separate fluid pump circulating the respective first, second and third portions of the liquid coolant through the first, second and third drying units.
